(19) United States
(12) Patent Application Publication
(10) Pub. No.: US 2013/0332276 A1
(43) Pub. Date: Dec. 12, 2013

(54) ADVERTISEMENT MANAGEMENT DEVICE, ADVERTISEMENT SELECTION DEVICE, ADVERTISEMENT MANAGEMENT METHOD, ADVERTISEMENT MANAGEMENT PROGRAM AND STORAGE MEDIUM STORING ADVERTISEMENT MANAGEMENT PROGRAM

(71) Applicant: Shinya Takami, Shinagawa-ku (JP)

(72) Inventor: Shinya Takami, Shinagawa-ku (JP)

(73) Assignee: RAKUTEN, INC., Tokyo (JP)

(21) Appl. No.: 14/001,055

(22) PCT Filed: Dec. 1, 2011
(86) PCT No.: PCT/JP2011/077849

§ 371 Date: Aug. 22, 2013

(30) Foreign Application Priority Data
Feb. 28, 2011 (JP) 2011-041931

(51) Int. Cl. G06Q 30/02

(52) U.S. Cl. CPC G06Q 30/0255; G06Q 30/0263
USPC 705/14.53

(57) ABSTRACT

An advertisement management device for managing an advertisement using advertisement information including information indicating association of an advertisement with a category includes an integration target category identifying unit that identifies an integration target category based on the advertisement information, the integration target category being a category in which the number of advertisements associated with the same category is equal to or less than a predetermined threshold, and an integration unit that associates the advertisement associated with the integration target category with a category different from the integration target category and updates the advertisement information.

### TECHNICAL FIELD

The present invention relates to an advertisement management device, an advertisement selection device, an advertisement management method, an advertisement management program and a recording medium storing the advertisement management program.

### BACKGROUND ART

Conventionally, a device for selecting an advertisement to be displayed on a web page based on content of the web page is known as a device for selecting an advertisement (e.g., see Patent Literatures 1 and 2). The device described in Patent Literature 1 has advertisement information classified into a plurality of categories in advance, determines a category of a web page based on a degree of similarity between a feature word included in the web page and a word set in advance, and selects the advertisement information in a category matching the category of the web page. The device of Patent Literature 2 has advertisement information classified into a plurality of categories in advance, calculates an attribution rate for each category based on text information included in a web page, selects a category of the web page based on the attribution rate, and selects the advertisement information in a category matching the category of the web page.

Further, a device for selecting an advertisement to be provided to a user based on a degree of relevance between a word input by a user or a word extracted from history information of the user and a word set in a category in advance is known as a device for selecting an advertisement (e.g., see Patent Literature 3). The device of Patent Literature 3 analyzes a preference of the user by calculating a degree of relevance between a phrase input by the user a predetermined number of times or more or a phrase extracted from the history information (manipulation history/viewing history) of the user and a phrase set in a plurality of categories in advance, and selects an advertisement to be distributed based on a result of the analysis.

### CITATION LIST

### Patent Literature

[Patent Literature 1] Japanese Patent Laid-Open Publication No. 2009-266204

[Patent Literature 2] Japanese Patent Laid-Open Publication No. 2008-097351

[Patent Literature 3] Japanese Patent Laid-Open Publication No. 2010-079683

### SUMMARY OF INVENTION

### Technical Problem

However, in a conventional advertisement selection device, an advertisement most suitable for content of a web page or preference of a user may not be selected. For example, since advertisement information is classified using an undifferentiated category determined in advance, relevance between a category and a product belonging to the category or relevance between products belonging to the category may be low. In this case, when an advertisement is selected in consideration of information of the category, content of the selected advertisement and content of the web page or the content of the selected advertisement and the preference of the user may differ.

In the technical field, in order to solve the aforementioned problem, there is a need for an advertisement management device, an advertisement selection device, an advertisement management method, an advertisement management program and a recording medium storing the advertisement management program capable of suppressing degradation of relevance between a category and an advertisement included in the category.

### Solution to Problem

An advertisement management device according to an aspect of the present invention is an advertisement management device for managing an advertisement using advertisement information including information indicating association of an advertisement with a category, the advertisement management device including: an integration target category identifying means that identifies an integration target category based on the advertisement information, the integration target category being a category in which the number of advertisements associated with the same category is equal to or less than a predetermined threshold; and an integration means that associates the advertisement associated with the integration target category with a category different from the integration target category and updates the advertisement information.

In the advertisement management device, the integration target category that is the category of which the number of advertisements associated with the same category is equal to or less than a predetermined threshold is identified by the integration target category identifying means based on advertisement information. The advertisement associated with the integration target category is associated with a category different from the integration target category and the advertisement information is updated by the integration means. When the number of advertisements associated with one category is smaller, an influence of one advertisement on the characteristic of the category is greater. Therefore, when the characteristic of the category is identified with the characteristic of the advertisement belonging to the category, and when one of the advertisements belonging to the category has a unique characteristic that other advertisements do not have, relevance between a concept of the category and content of the advertisement belonging to the category may be degraded. Therefore, it is possible to suppress the degradation of the relevance between the category and the advertisement included in the category by integrating the categories of which the number of advertisements is equal to or less than a predetermined threshold.

Further, an advertisement management device according to another aspect of the present invention is an advertisement management device for managing an advertisement using advertisement information including information indicating association of an advertisement with a category and a history of the number of displays of the advertisement, the advertisement management device including: an integration target category identifying means that identifies an integration target category based on the advertisement information, the integration target category being a category in which a sum of the numbers of displays of advertisements associated with the same category is equal to or less than a predetermined threshold; and an integration means that associates the advertisement associated with the integration target category with a category different from the integration target category and updates the advertisement information.

In this advertisement management device, the integration target category that is the category of which the sum of the number of displays of the advertisements associated with the same category is equal to or less than a predetermined threshold is identified by the integration target category identifying means based on the advertisement information. The advertisement associated with the integration target category is associated with a category different from the integration target category and the advertisement information is updated by the integration means. In the case of the category of which the total number of displays is small, existence of the category itself may be inappropriate. Therefore, it is possible to suppress degradation of the relevance between the category and the advertisements included in the category by performing integration when the total number of displays is equal to or less than the predetermined threshold.

In an embodiment, the integration means may calculate a degree of similarity between a feature word extracted from the advertisement associated with the integration target category and a name of the category different from the integration target category, associate an advertisement included in the category whose calculated degree of similarity is equal to or more than a predetermined threshold and the advertisement associated with the integration target category with a new category and update the advertisement information. Through this configuration, integration with the category having the name similar to the characteristic of the advertisement can be performed.

In an embodiment, the integration means may calculate a degree of similarity between a name of the integration target category and a name of the category different from the integration target category, associate an advertisement included in the category whose calculated degree of similarity is equal to or more than a predetermined threshold and the advertisement associated with the integration target category with a new category, and update the advertisement information. Through this configuration, categories having similar category names can be integrated.

Further, an advertisement selection device according to still another aspect of the present invention is an advertisement selection device including the advertisement management device according to any one of claims 1 to 4, wherein: the advertisement information further includes information indicating association of an advertisement with a keyword, and information indicating association of the advertisement with text information, and the advertisement selection device includes: a web information acquisition means that acquires a feature word and text information from a web page designated by a user; a word score calculation unit that calculates a word score indicating a degree of linguistic relevance for each advertisement based on the feature word of the web page and the keyword associated with the advertisement; a category score calculation unit that calculates a category score indicating a degree of linguistic relevance for each category based on the text information of the web page and the text information associated with the advertisement; and a selection means that selects an advertisement to be displayed on the web page based on the word score and the category score.

According to this advertisement selection device, since the advertisement management device described above is included, the advertisement can be selected using the word score and the category score based on the advertisement information classified in an appropriate category. Therefore, it is possible to select the advertisement most suitable for content of the web page.

Further, an advertisement management method according to still another aspect of the present invention is an advertisement management method by an advertisement management device for managing an advertisement using advertisement information including information indicating association of an advertisement with a category, the advertisement management method including: an integration target category identifying step of identifying an integration target category based on the advertisement information, the integration target category being a category in which the number of advertisements associated with the same category is equal to or less than a predetermined threshold; and an integration step of associating the advertisement associated with the integration target category with a category different from the integration target category and updating the advertisement information.

Further, an advertisement management method according to still another aspect of the present invention is an advertisement management method by an advertisement management device for managing an advertisement using advertisement information including information indicating association of an advertisement with a category and a history of the number of displays of the advertisement, the advertisement management method including: an integration target category identifying step of identifying an integration target category based on the advertisement information, the integration target category being a category in which a sum of the numbers of displays of advertisements associated with the same category is equal to or less than a predetermined threshold; and an integration step of associating the advertisement associated with the integration target category with a category different from the integration target category and updating the advertisement information.

Further, an advertisement management program according to still another aspect of the present invention is an advertisement management program for causing one or a plurality of computers to realize a function of managing an advertisement using advertisement information including information indicating association of the advertisement with a category, wherein the advertisement management program causes the one or plurality of computers to realize functions of an integration target category identifying means that identifies an integration target category based on the advertisement information, the integration target category being a category in which the number of advertisements associated with the same category is equal to or less than a predetermined threshold; and an integration means that associates the advertisement associated with the integration target category with a category different from the integration target category and updates the advertisement information.

Further, a recording medium according to still another aspect of the present invention is a computer-readable recording medium having an advertisement management program recorded thereon for causing one or a plurality of computers to realize a function of managing an advertisement using advertisement information including information indicating association of an advertisement with a category, wherein the advertisement management program causes the one or plurality of computers to realize functions of an integration target category identifying means that identifies an integration target category based on the advertisement information, the integration target category being a category in which the number of advertisements associated with the same category is equal to or less than a predetermined threshold; and an integration means that associates the advertisement associated with the integration target category with a category different from the integration target category and updates the advertisement information.

With the advertisement management method, the advertisement management program and the recording medium according to still another aspect of the present invention, it is possible to achieve the same effects as the advertisement management device described above.

### Advantageous Effects of Invention

According to various aspects and embodiments of the present invention, it is possible to suppress degradation of relevance between the category and an advertisement included in the category.

### BRIEF DESCRIPTION OF DRAWINGS

FIG. 1 is an overview diagram of a system including an advertisement server according to a first embodiment.

FIG. 2 is a block diagram illustrating a configuration of a system including an advertisement management device according to the first embodiment.

FIG. 3 is a hardware configuration diagram of each server.

FIG. 4 is an example of data stored in an advertisement management database.

FIG. 5 is an example of data stored in a category database.

FIG. 6 is a flowchart illustrating an operation for a reorganization process in the advertisement management device according to the first embodiment.

FIG. 7 is a flowchart illustrating an operation for a division process in the advertisement management device according to the first embodiment.

FIG. 8 is a flowchart illustrating an operation for an integration process in the advertisement management device according to the first embodiment.

FIG. 9 is a flowchart illustrating an operation for an advertisement selection process in an advertisement server according to the first embodiment.

FIG. 10 is an example of a ranking of keywords in a category.

FIG. 11 is an example of a score ranking of an advertisement.

FIG. 12 is a flowchart illustrating an operation for an advertisement selection process in an advertisement server according to a second embodiment.

### DESCRIPTION OF EMBODIMENTS

Hereinafter, an advertisement management device, an advertisement selection device, an advertisement management method, an advertisement management program, and a recording medium storing the advertisement management program according to embodiments will be described with reference to an attached drawing. Further, in a description of the drawings, the same elements are denoted by the same reference numerals, and a repeated description is omitted.

(First embodiment) An advertisement management device, an advertisement server (an advertisement selection device), an advertisement management method, an advertisement management program, and an advertisement management program according to the first embodiment are, for example, suitably adopted for service of providing an advertisement inserted into a web page.

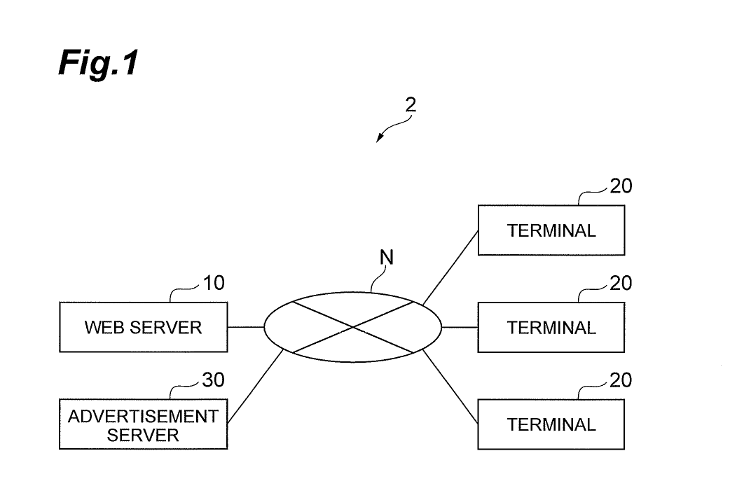

First, a configuration of a web system 2 including an advertisement server according to the first embodiment will be described. FIG. 1 is an overview diagram schematically illustrating the configuration of the web system 2. The web system 2 shown in FIG. 1 is a computer system that provides a web page to a user and collects user manipulations on the web page. The web system 2 includes a web server 10 that provides the web page, an advertisement server 30 that selects an advertisement to be inserted into the web page, and terminals 20 that provide the web page to users, as shown in FIG. 1. The web server 10, the advertisement server 30 and each terminal 20 can communicate with each other over a communication network N, which includes the Internet, a wireless LAN, a mobile communication network or the like. Further, in FIG. 1, three terminals 20 are shown, but the number of terminals present in the web system 2 is arbitrary.

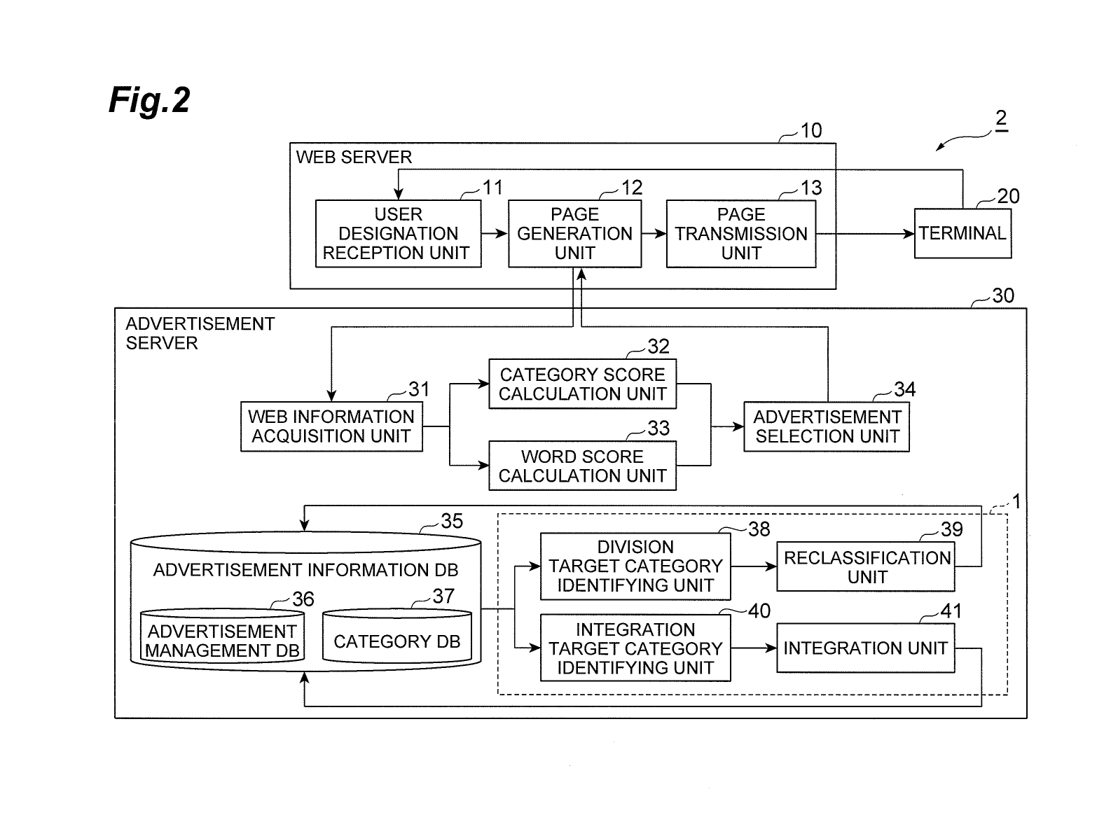

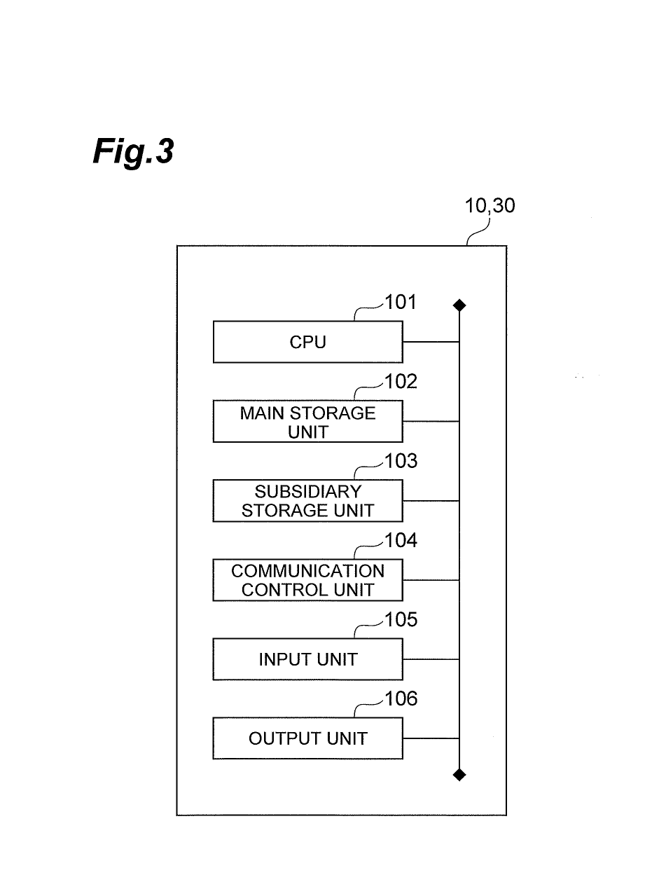

Next, a configuration of the web server 10 and the advertisement server 30 will be described in detail. FIG. 2 is a functional block diagram of the web system 2, and FIG. 3 is a hardware configuration diagram of each server. The web server 10 or the advertisement server 30 in FIG. 2 includes a CPU 101 that executes an operating system, an application program or the like, a main storage unit 102 including a ROM and a RAM, a subsidiary storage unit 103 including a hard disk or the like, a communication control unit 104 including a network card or the like, an input unit 105 such as a keyboard or a mouse, and an output unit 106 such as a monitor, as shown in FIG. 3. Each function shown in FIG. 2 is realized by loading predetermined software on the CPU 101 or the main storage unit 102, operating the communication control unit 104, the input unit 105, the output unit 106 or the like under control of the CPU 101, and performing reading and writing of data in the main storage unit 102 or the subsidiary storage unit 103. Data or a database necessary for a process is stored within the main storage unit 102 and the subsidiary storage unit 103.

The web server 10 includes a user designation reception unit 11, a page generation unit 12, and a page transmission unit 13 as functional components, as shown in FIG. 2.

The user designation reception unit 11 has a function of receiving a request signal transmitted from the terminal 20 according to a manipulation of the user. For example, URL information desired to be displayed by the user is included in the request signal. Further, the user designation reception unit 11 has a function of outputting the received request signal to the page generation unit 12. The page generation unit 12 has a function of generating a web page according to the request signal. The page generation unit 12 has a function of transmitting information on the generated web page to the advertisement server 30 and receiving information on an advertisement to be inserted into the web page from the advertisement server 30. Also, the page generation unit 12 has a function of generating a web page into which the advertisement has been inserted based on the received information on the advertisement and outputting the generated web page to the page transmission unit 13. The page transmission unit 13 has a function of transmitting the web page having the advertisement inserted thereinto to the terminal 20. Further, the terminal 20 has a function of receiving a user manipulation and displaying the web page.

The advertisement server 30 selects an advertisement to be inserted into the web page and provides the advertisement to the web server 10, and may include an advertisement management device 1 and an advertisement information DB 35. The advertisement management device 1 is configured to be able to refer to the advertisement information DB 35, and has a function of managing information of the advertisement information DB 35. The information on the advertisement to be inserted into the web page is stored in the advertisement information DB 35. The advertisement information DB 35 includes an advertisement management DB 36 and a category DB 37 for managing advertisements, in addition to real data of the advertisement (e.g., including image information or video information, as well as text data).

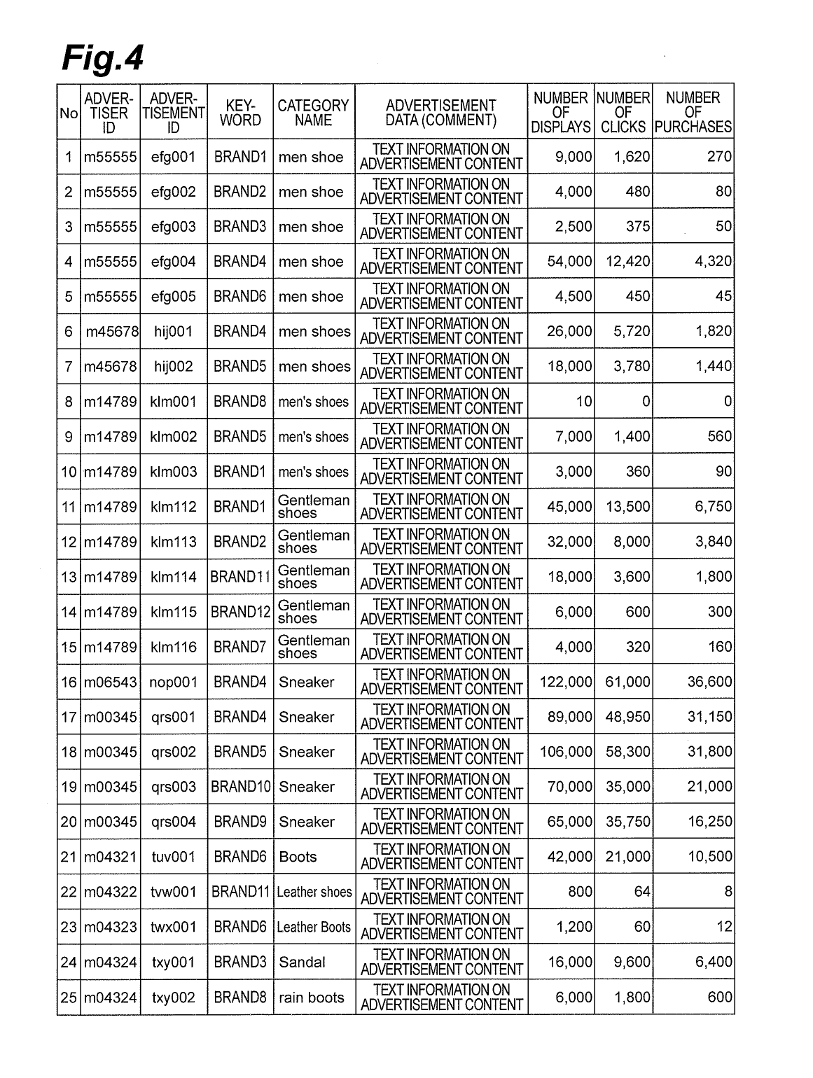

Hereinafter, data stored in the advertisement management DB 36 and the category DB 37 will be described in detail. FIG. 4 is an example of the data stored in the advertisement management DB 36. An advertisement information table is stored in the advertisement management DB 36, as shown in FIG. 4. For example, the table having, as data items, “advertiser ID” that is an identifier for uniquely identifying an advertiser, “advertisement ID” that is an identifier for uniquely identifying an advertisement, “keyword” that is characters indicating content of the advertisement or a characteristic of a product, “category name” indicating a category that the advertisement belongs to, “advertisement data (comment)” that is text information on advertisement content, “number of displays” that is the number of times the advertisement has been inserted into the web page, “number of clicks” that is the number of times the advertisement has been clicked on the web page, and “number of purchases” indicating the number of purchases through the advertisement is stored. Further, the data items “advertisement ID” and “category name” are essential. In other words, the advertisement information has a hierarchical structure classified into categories. The other data items may be appropriately changed according to required service forms. Further, “category name” may indicate, as an initial value, a category that the advertiser selects from among categories defined on the system side in advance or may indicate a category defined by the advertiser in advance. Further, the category name is appropriately changed by the advertisement management device 1, as will be described below.

“Advertiser ID,” “advertisement ID,” “keyword,” “category name” and “advertisement data” are stored in the advertisement management DB 36 at the time of registration of the advertisement information. For example, a brand name of an advertisement product is stored as “keyword.” Further, for “category name,” a category name allocated in advance or defined by an advertiser in advance is stored as an initial value. For “advertisement data,” for example, text information extracted from the real data of the advertisement is stored. Among the data items, “category name” may be changed by the advertisement management device 1, as will be described below. Further, “number of displays,” “number of clicks” and “number of purchases” are stored as history information. In other words, for “number of displays,” “number of clicks” and “number of purchases,” a total number of times up to the present or the number of times in each unit period is stored as a history. “Number of displays” may be counted and collected when the advertisement server 30 selects the advertisement or may be collected over the network N from the web server 10 or the terminal 20. Further, “number of clicks” and “number of purchases” are collected over the network N from the web server 10 or the terminal 20.

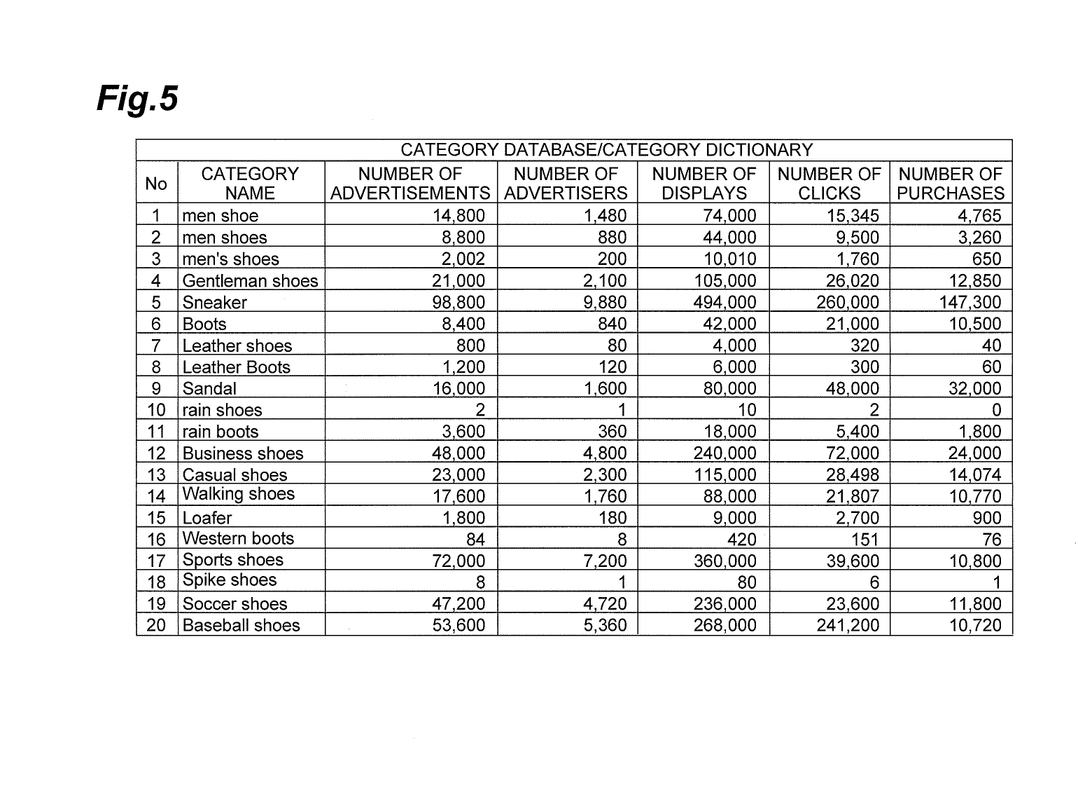

Next, the category DB 37 will be described. FIG. 5 is an example of data stored in the category DB 37. A table of information on the category is stored in the category DB 37, as shown in FIG. 5. For example, a table having, data items, “category name” that is an identifier for uniquely identifying a category, “number of advertisements” that is the number of advertisements associated with the category, “number of displays” that is a total number of displays in units of categories, “number of clicks” that is a total number of clicks in units of categories, and “number of purchases” that is a total number of purchases in units of categories is stored. Thus, the category DB 37 is configured to functions as a category dictionary in which information is collected in units of categories. Further, the data stored in the category DB 37 is generated based on the information stored in the advertisement management DB 36. For example, the data stored in the category DB 37 may be acquired by performing collection using the category name of the table in the advertisement management DB 36 as a key. Therefore, the category DB 37 may be included as necessary.

Next, the advertisement management device 1 will be described in detail. As shown in FIG. 2, the advertisement management device 1 is configured to be able to refer to and update the advertisement information DB 35 and includes a division target category identifying unit (a division target category identifying means) 38 and a reclassification unit (a reclassification means) 39 that execute a category division process, and an integration target category identifying unit (an integration target category identifying means) 40 and an integration unit (an integration means) 41 that execute a category integration process.

First, the division target category identifying unit 38 and the reclassification unit 39 that execute the category division process will be described in detail. The division target category identifying unit 38 has a function of identifying a category that is a division target (a division target category) based on the advertisement information table stored in the advertisement management DB 36 or the category information table stored in the category DB 37. For example, the division target category identifying unit 38 has a function of identifying a category in which the number of advertisements associated with the same category is equal to or more than a first threshold, as the division target category. For example, the numbers of advertisements in units of categories are arranged in descending order, and the average number of advertisements calculated by dividing the number of advertisements in the categories included in the top 10% of all categories by the number of categories included in the top 10% is used as the first threshold. Further, n times (e.g., n=5) the average number of advertisements of the categories obtained by dividing the total number of advertisements by the number of categories may be used as the first threshold, or a fixed value (e.g., 10000) may be adopted.

Alternatively, the division target category identifying unit 38 has a function of identifying a division target category based on the number of displays. Hereinafter, two schemes of identifying the division target category based on the number of displays will be described. A first scheme is a scheme of calculating a deviation of the number of displays of each advertisement associated with the same category and determining whether the category is the division target category. For example, the division target category identifying unit 38 acquires a total number of displays of advertisements associated with the same category based on the advertisement information table or the category information table, acquires, for each advertisement, the number of displays of the advertisement associated with the category based on the advertisement information table, and calculates, for each advertisement, a ratio of the number of displays of the advertisement to the total number of displays of the category. The calculated ratio indicates a deviation of the number of displays of the advertisement. Also, when there is an advertisement of which the ratio of the number of displays is equal to or more than the second threshold, it may be determined that there is a deviation in the advertisement displayed in the same category, and accordingly, the category associated with the advertisement is identified as the division target category. As the second threshold, for example, a fixed value such as 0.8 is adopted.

A second scheme is a scheme of calculating a deviation of an advertisement to be displayed in the same category to determine whether the category is the division target category. For example, the division target category identifying unit 38 acquires a total number of displays of advertisements associated with the same category based on the advertisement information table or the category information table. Also, the division target category identifying unit 38 calculates a sum of the numbers of displays of the advertisements belonging to a top n% (e.g., n=20) of the numbers of displays in the category based on the advertisement information table. Also, the division target category identifying unit 38 calculates a ratio (a degree of deviation) of the sum of the numbers of displays of the advertisements belonging to the top n% to the total number of displays of the category. Accordingly, the degree of deviation of the display is calculated in units of categories. Also, when the degree of deviation is equal to or more than a third threshold, it may be determined that there is a deviation in displayed advertisements in the same category, and accordingly, the category is identified as the division target category. As the third threshold, for example, a fixed value such as 0.8 is adopted.

Furthermore, the division target category identifying unit 38 has a function of outputting information on the identified division target category to the reclassification unit 39.

The reclassification unit 39 has a function of dividing the division target category and reclassifying the advertisements. For example, the reclassification unit 39 has a function of re-associating some of the advertisements associated with the division target category with a category different from the division target category based on the information on the division target category output by the division target category identifying unit 38. The category different from the division target category may be an existing category or may be a new category newly produced by the reclassification unit 39. As a scheme of identifying the classification target advertisements, for example, the reclassification unit 39 divides (classifies) advertisements in such a manner that an advertisement of which the number of displays is equal to or more than a fourth threshold and an advertisement of which the number of displays is less than the fourth threshold belong to different categories. As the fourth threshold, for example, an average number of displays of the division target category calculated by dividing a total number of displays of the division target category by the number of advertisements associated with the division target category is adopted. Further, as the fourth threshold, n times the average number of displays may be adopted. Further, the reclassification unit 39 may divide the advertisements so that an advertisement of which the deviation of the number of displays is equal to or more than a threshold and the other advertisements belong to different categories. Alternatively, the reclassification unit 39 may classify the advertisements into advertisements of a top n% of the numbers of displays among advertisements associated with the division target category, and the other advertisements. Alternatively, when the advertisement information includes information indicating association of a subcategory that is a subordinate concept of the category with the advertisement, the reclassification unit 39 may re-associate the subcategory of the advertisement associated with the division target category as the category of the advertisement. Alternatively, the reclassification unit 39 may extract a feature word from the advertisement associated with the division target category, produce a new category using the extracted feature word, and re-associate advertisements having the same or a similar feature word among the advertisements associated with the division target category with the new category. The reclassification unit 39 has a function of changing the association of the advertisement with the category using any one scheme described above and updating the advertisement information table stored in the advertisement management DB 36 and the category information table stored in the category DB 37.

Next, the integration target category identifying unit 40 and the integration unit 41 that execute the category integration process will be described in detail. The integration target category identifying unit 40 has a function of identifying a category that is an integration target (an integration target category) based on the advertisement information table stored in the advertisement management DB 36 or the category information table stored in the category DB 37. For example, the integration target category identifying unit 40 has a function of identifying, as the integration target category, a category of which the number of advertisements associated with the same category is equal to or less than a fifth threshold. As the fifth threshold, for example, an average number of advertisements calculated by arranging the numbers of advertisements in units of categories in a descending order and dividing the number of advertisements in the categories included in the bottom 10% of all categories by the number of the categories included in the bottom 10% is used. Further, n% of the total number of advertisements (e.g., n=20) or a fixed value (e.g., 10) may be adopted as the fifth threshold.

Alternatively, the integration target category identifying unit 40 has a function of identifying the integration target category based on the number of displays. The integration target category identifying unit 40 has a function of identifying the integration target category that is a category of which a total number of displays of advertisements associated with the same category is equal to or less than a sixth threshold, based on the advertisement information table or the category information table. As the sixth threshold, for example, n times (e.g., n=1) the average number of advertisements of the category obtained by dividing the total number of advertisements by the number of categories is adopted.

Furthermore, the integration target category identifying unit 40 has a function of outputting information on the identified integration target category to the integration unit 41.

The integration unit 41 has a function of integrating integration target categories and reclassifying advertisements. For example, the integration unit 41 has a function of re-associating an advertisement associated with the integration target category with a category different from the integration target category based on the information on an integration target category output by the integration target category identifying unit 40. The category different from the integration target category is an existing category.

The integration unit 41 has, for example, a function of comparing a category name of the integration target category with a category name of another category to calculate a degree of similarity, and identifying a category of which the calculated degree of similarity is equal to or more than a second threshold as an integration destination category. As a method of comparing the category names, for example, comparison of all character strings, comparison of normalized character strings (synonym conversion, normalization, and specific character string deletion referring to a synonym dictionary), or comparison of some character strings is adopted. Further, as a method of determining a degree of similarity, for example, a scheme of using a Jaro distance or a Levenshtein distance is adopted. Further, as the seventh threshold, for example, 0.8 is adopted when the degree of similarity is evaluated using the Jaro distance.

Alternatively, the integration unit 41 has a function of comparing a feature word extracted from the advertisement associated with the integration target category with a feature word extracted from the advertisement associated with another category to calculate a degree of similarity, and identifying a category of which the calculated degree of similarity is equal to or more than a seventh threshold as an integration destination category. The integration unit 41, for example, extracts a feature word from “advertisement data (comment)” that is text information on advertisement content through TF/IDF, morphological analysis or the like with reference to the advertisement information table in the advertisement management DB 36. Further, the integration unit 41 may directly extract the text information from real data of the advertisement. Further, as a method of determining a degree of similarity, for example, a scheme of using a Jaro distance or a Levenshtein distance is adopted. Further, as the seventh threshold, for example, 0.8 is adopted when the degree of similarity is evaluated using the Jaro distance.

The integration unit 41 has a function of changing the association of the advertisement with the category using any scheme described above, and updating the advertisement information table stored in the advertisement management DB 36 and the category information table stored in the category DB 37.

Next, an advertisement selection function of the advertisement server 30 will be described. The advertisement server 30 includes a web information acquisition unit (a web information acquisition means) 31, a category score calculation unit (a category score calculation means) 32, a word score calculation unit (a word score calculation means) 33, and an advertisement selection unit (a selection means) 34.

The web information acquisition unit 31 has a function of receiving the information on the web page according to the request signal of the terminal from the web server 10. The web information acquisition unit 31 has a function of acquiring the feature word and text information from the web page based on the received information. Furthermore, the web information acquisition unit 31 has a function of outputting the acquired text information to the category score calculation unit 32, and a function of outputting the acquired feature word to the word score calculation unit 33.

The category score calculation unit 32 is configured to be able to refer to the advertisement information DB 35, and has a function of acquiring the text information included in each advertisement based on the advertisement information table. Also, the category score calculation unit 32 has a function of calculating a category score of each category by comparing the text information extracted from the web page by the web information acquisition unit 31 with the text information included in each advertisement. The category score is a score calculated based on a degree of linguistic relevance of a character string included in the web page and a character string included in the advertisement belonging to the target category. A higher category score indicates that the content of the web page and the content of the category are more closely related to each other. For example, the category score calculation unit 32 extracts a keyword frequently appearing for each category, and produces a category dictionary in which the keyword and the frequency are associated. Further, the category score calculation unit 32 extracts a plurality of keywords from the text information of the web page. Also, the category score calculation unit 32 performs matching of the keywords using a ranking of the frequency and the number of words as weights to calculate the category score. The category score calculation unit 32 has a function of outputting the calculated category score to the advertisement selection unit 34.

The word score calculation unit 33 is configured to be able to refer to the advertisement information DB 35, and has a function of acquiring a keyword of each advertisement based on the advertisement information table. Also, the word score calculation unit 33 has a function of calculating a word score of each advertisement by comparing the feature word extracted from the web page by the web information acquisition unit 31 with the keyword of each advertisement. The word score is a score calculated based on a degree of linguistic relevance between a character string included in the web page and a character string included in the advertisement. A higher word score indicates that the content of the web page is related to content of the advertisement. For example, the word score calculation unit 33 performs matching of the feature word with the keyword to calculate the word score. The word score calculation unit 33 has a function of outputting the calculated word score to the advertisement selection unit 34.

The advertisement selection unit 34 has a function of calculating a total score of the advertisement based on the category score output by the category score calculation unit 32 and the word score output by the word score calculation unit 33. Also, the advertisement selection unit 34 has a function of ranking the advertisements based on the total score and selecting (identifying) the advertisement to be inserted into the web page. For example, the advertisement selection unit 34 selects advertisements up to a ranking x based on the ranking and the number×of advertisement display frames of the web page. The advertisement selection unit 34 has a function of transmitting information on the selected advertisement to the web server 10. The information to be transmitted may be, for example, only a selected advertisement ID or may be only real data.

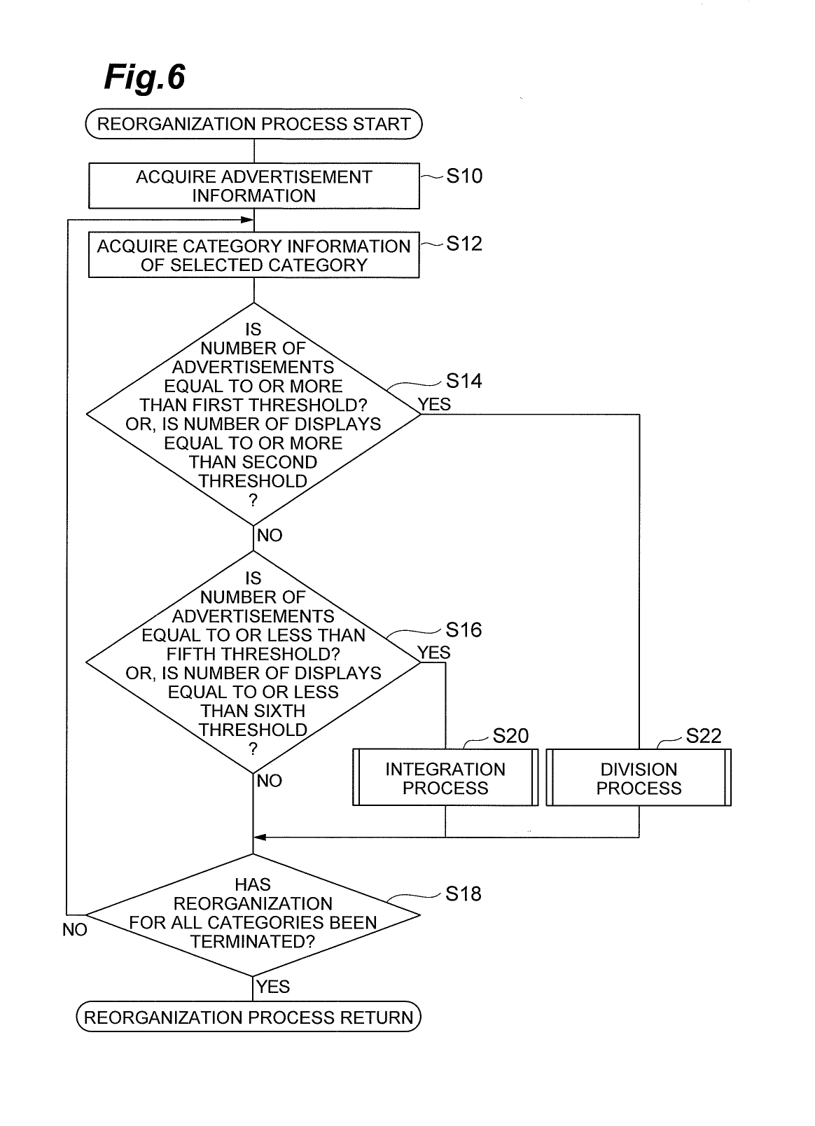

Next, an operation of the advertisement management device 1 of the advertisement server 30 configured as described above will be described with reference to a flowchart. First, an operation of managing the advertisement information DB 35 will be described. FIG. 6 is a flowchart illustrating a DB reorganization operation of the advertisement management device 1 in the present embodiment. A control process shown in FIG. 6 is executed, for example, at a timing at which an advertisement included in the advertisement information DB 35 increases or decreases.

As shown in FIG. 6, the control process starts from an advertisement information acquisition process (S10). In the process of S10, the advertisement management device 1 acquires “advertiser ID,” “advertisement ID,” “keyword,” “category name,” “advertisement data,” “number of displays,” “number of clicks” and “number of purchases” for each advertisement based on the advertisement information table with reference to the advertisement management DB 36. When the process of S10 is terminated, the control process proceeds to a category information acquisition process (S12).

In the process of S12, the advertisement management device 1 selects a processing target category, and acquires “category name,” “number of advertisements,” “number of displays,” “number of clicks” and “number of purchases” of the processing target category based on the advertisement information table or the category table with reference to the advertisement information DB 35. When the process of S12 is terminated, the control process proceeds to a division trigger determination process (S14).

In the process of S14, the division target category identifying unit 38 determines whether the category selected in the process of S12 is the division target category. The division target category identifying unit 38, for example, determines whether the number of advertisements in units of categories acquired in the process of S12 is equal to or more than the first threshold. Or, the division target category identifying unit 38 calculates a ratio of the number of displays of the advertisement based on the number of displays in units of advertisements acquired in the process of S10 and determines whether the calculated ratio of the number of displays of the advertisement is equal to or more than the second threshold. When the number of advertisements in units of categories is equal to or more than the first threshold or the number of displays in units of advertisements is equal to or more than the second threshold in the process of S14, the control process proceeds to a division process (S22). Further, a determination may be made as to whether a degree of deviation of the displayed advertisement is equal to or more than the third threshold and the control process may proceed to the division process.

The reclassification unit 39 executes the process of S22. This process will be described below. When the process of S22 is terminated, the control process proceeds to a termination determination process (S18).

On the other hand, when the number of advertisements in units of categories is not equal to or more than the first threshold and the number of displays in units of advertisements is not equal to or more than the second threshold in the process of S14, the control process proceeds to the integration trigger determination process (S16). Further, when the degree of deviation of displayed advertisements is not equal to or more than the third threshold, the control process proceeds to the integration trigger determination process (S16). In the process of S16, the integration target category identifying unit 40 determines whether the category selected in the process of S12 is the integration target category. The integration target category identifying unit 40 determines, for example, whether the number of advertisements in units of categories acquired in the process of S12 is equal to or more than the fifth threshold or whether the number of displays in units of categories acquired in the process of S12 is equal to or more than the sixth threshold. When the number of advertisements in units of categories is equal to or more than the fifth threshold or the number of displays in units of categories is equal to or more than the sixth threshold in the process of S16, the control process proceeds to an integration process (S20).

The integration unit 41 executes the process of S20. This process will be described below. When the process of S20 is terminated, the control process proceeds to the termination determination process (S18).

On the other hand, in the process of S16, when the number of advertisements in units of categories is not equal to or more than the fifth threshold and the number of displays in units of categories is not equal to or more than the sixth threshold, the control process proceeds to the termination determination process (S18).

The advertisement management device 1 executes the process of S18, which is a process of determining whether the reorganization determination for all the categories has been terminated. When the reorganization determination for all the categories is determined not to have been terminated, the control process proceeds to the process of S12 again. Therefore, the processes of S14, S16, S20 and S22 are repeatedly executed until the reorganization determination for all the categories is terminated. On the other hand, when the reorganization determination for all the categories is determined to have been terminated, the control process shown in FIG. 6 ends.

Thus, the control process shown in FIG. 6 ends. When the control process shown in FIG. 6 is executed, the category that is a reorganization target of division or integration is appropriately determined and processed.

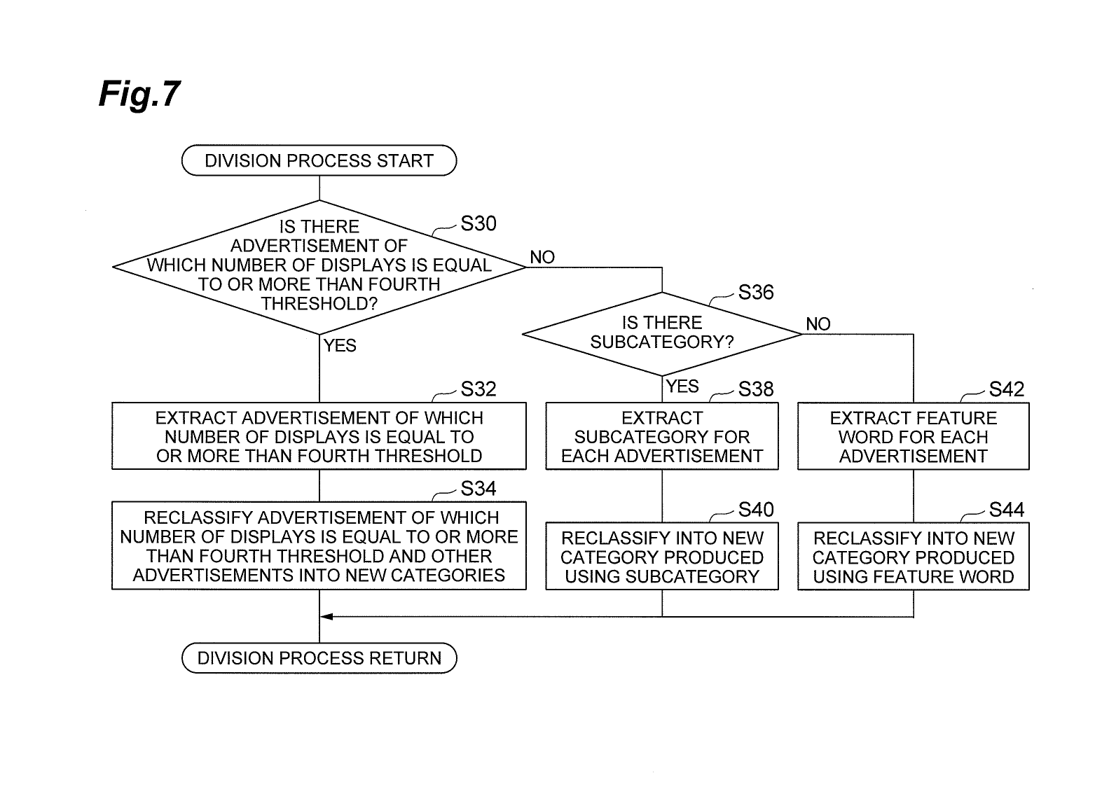

Next, a category division process will be described in detail. FIG. 7 is a flowchart illustrating a category division operation of the advertisement management device 1 in the present embodiment.

The process starts from a process of determining the number of displays as shown in FIG. 7 (S30). In the process of S30, the reclassification unit 39 determines whether an advertisement of which the number of displays is equal to or more than the fourth threshold is included based on the number of displays for each advertisement acquired in the process of S10. Further, the reclassification unit 39 may determine whether a predetermined number or more of advertisements of which the number of displays is equal to more than the fourth threshold are included. When the advertisement of which the number of displays is equal to or more than the fourth threshold is determined to be included in the process of S30, the control process proceeds to an extraction process (S32).

In the process of S32, the reclassification unit 39 extracts the advertisement of which the number of displays is equal to or more than the fourth threshold, which has been determined in the process of S30. When the process of S32 is terminated, the control process proceeds to a category division process (S34).

In the process of S34, the reclassification unit 39 produces new categories, and re-associates the advertisement extracted in the process of S32 and the other advertisements with the new different categories. For example, the reclassification unit 39 associates the advertisement of which the number of displays is equal to or more than the fourth threshold with a first new category and associates the advertisement not associated with the first new category among advertisements associated with the processing target category with a second new category. Also, the reclassification unit 39 updates the advertisement information DB 35. When the process of S34 is terminated, the control process shown in FIG. 7 ends.

On the other hand, when it is determined in the process of S30 that no advertisement of which the number of displays is equal to or more than the fourth threshold is included, the control process proceeds to a subcategory determination process (S36). In the process of S36, the reclassification unit 39 determines whether a subcategory has been associated with the advertisement associated with the processing target category based on the advertisement information table with reference to the advertisement management DB 36. When it is determined in the process of S36 that the subcategory has been associated, the control process proceeds to an extraction process (S38).

In the process of S38, the reclassification unit 39 extracts a subcategory for each piece of advertisement information. When the process of S38 is terminated, the control process proceeds to a category division process (S40).

In the process of S40, the reclassification unit 39 produces a new category, uses a name of the subcategory extracted in the process of S38 as a name of the new category, and re-associates the subcategory associated with the advertisement associated with the processing target category, as a category of the advertisement. Also, the reclassification unit 39 updates the advertisement information DB 35. When the process of S40 is terminated, the control process shown in FIG. 7 ends.

On the other hand, when it is determined in the process of S36 that the subcategory has not been associated, the control process proceeds to a feature word extraction process (S42). In the process of S42, the reclassification unit 39 extracts a feature word from real data or the like of the advertisement. When the process of S42 is terminated, the control process proceeds to a category division process (S44).

In the process of S44, the reclassification unit 39 produces a new category, uses a feature word extracted in the process of S42 as a name of the new category, and associates the advertisements with the new category so that advertisements having similar feature words are classified together. Also, the reclassification unit 39 updates the advertisement information DB 35. When the process of S44 is terminated, the control process shown in FIG. 7 ends.

Thus, the control process of FIG. 7 ends. When the control process shown in FIG. 7 is executed, the division target category is appropriately divided into a plurality of categories.

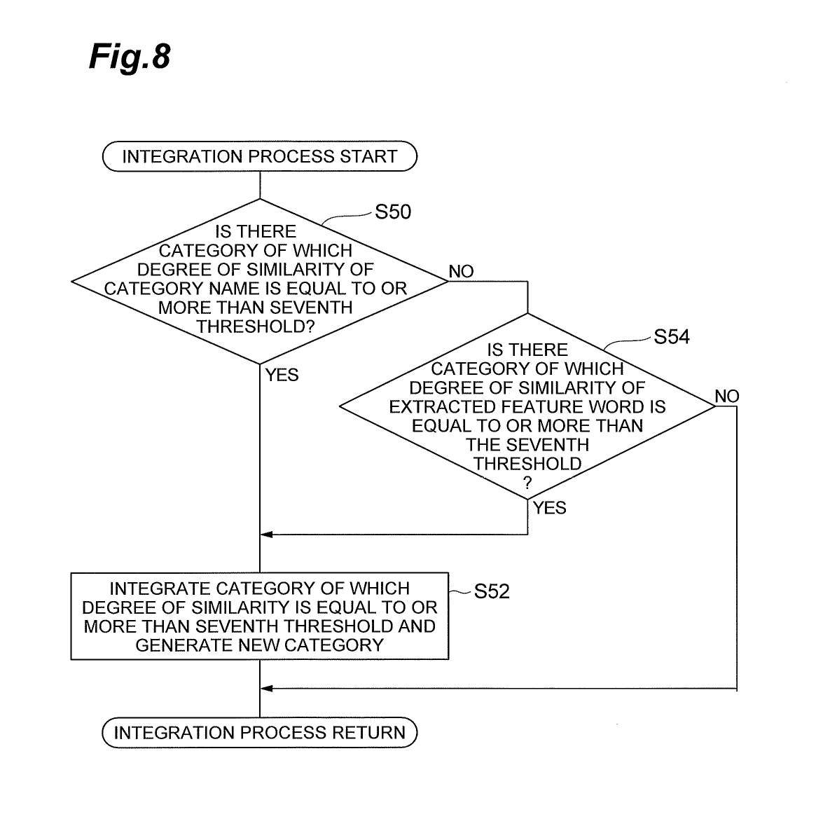

Next, the category integration process will be described in detail. FIG. 8 is a flowchart illustrating a category integration operation of the advertisement management device 1 in the present embodiment.

The process starts from a category name determination process as shown in FIG. 8 (S50). In the process of S50, the integration unit 41 calculates a degree of similarity between the name of the processing target category and the name of another category. Also, the integration unit 41 determines whether there is a category whose degree of similarity is equal to or more than the seventh threshold. When it is determined in the process of S50 that there is a category whose degree of similarity is equal to or more than the seventh threshold, the control process proceeds to an integration process (S52).

In the process of S52, the integration unit 41 produces a new category and integrates the processing target category and the category whose degree of similarity is equal to or more than the seventh threshold. The integration unit 41 re-associates all advertisements associated with the processing target category and the category whose degree of similarity is equal to or more than the seventh threshold with the new category. Also, the integration unit 41 updates the advertisement information DB 35. Further, In this case, the integration unit 41 may store the category before integration as a subcategory. Through this configuration, the subcategory is given by repeating the process. When the process of S52 is terminated, the control process shown in FIG. 8 ends.

On the other hand, when it is determined in the process of S50 that there is no category whose degree of similarity is equal to or more than the seventh threshold, the control process proceeds to a feature word determination process (S54). In the process of S54, the integration unit 41 calculates a degree of similarity of the category based on the feature word of the category extracted from the advertisement associated with the processing target category and the feature word of the category extracted from the advertisement associated with the other category. The integration unit 41 determines whether there is a category whose degree of similarity is equal to or more than the seventh threshold. When it is determined in the process of S54 that there is a category whose degree of similarity is equal to or more than the seventh threshold, the control process proceeds to the integration process (S52). On the other hand, when it is determined in the process of S54 that there is no category whose degree of similarity is equal to or more than the seventh threshold, the control process shown FIG. 8 ends.

Thus, the control process of FIG. 8 ends. When the control process shown in FIG. 8 is executed, the division target category is appropriately integrated into a similar category.

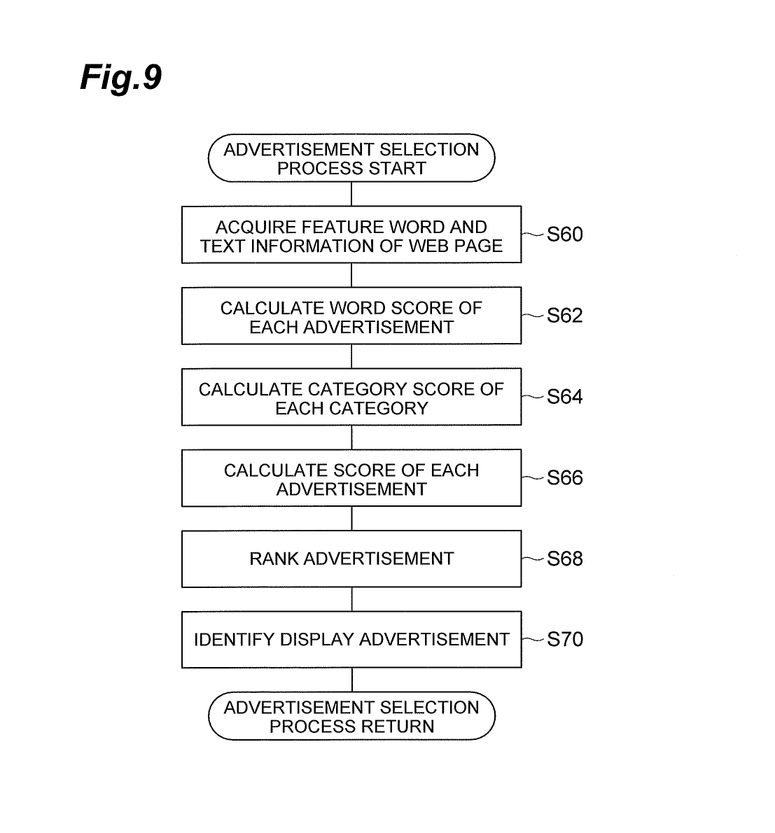

Next, an advertisement selection process of the advertisement server 30 will be described in detail. FIG. 9 is a flowchart illustrating an advertisement selection operation of the advertisement server 30. The control process shown in FIG. 9 is executed, for example, according to a request from the web server 10.

First, the web information acquisition unit 31 acquires a feature word and text information of the web page, as shown in FIG. 9 (S60). When the process of S60 is terminated, the control process proceeds to a word score calculation process (S62).

In the process of S62, the word score calculation unit 33 calculates a word score of each advertisement. For example, the word score calculation unit 33 matches the feature word acquired in the process of S60 with the keyword stored in the advertisement information table stored in the advertisement information DB 35 to calculate the word score of each advertisement. When the process of S62 is terminated, the control process proceeds to a category score calculation process (S64).

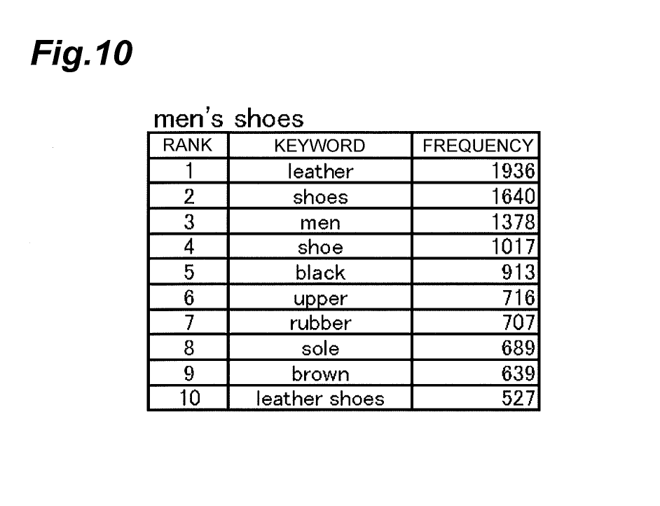

In the process of S64, the category score calculation unit 32 calculates a category score based on the text information acquired in the process of S60 and the text information stored in the advertisement information table. First, the category score calculation unit 32 produces a category dictionary based on the text information stored in the advertisement table. This process will be described with reference to FIG. 10. FIG. 10 is an example of a ranking of keywords in a category “Men's shoes.” The category score calculation unit 32 produces the category dictionary by extracting keywords frequently appearing in the text information of “Men's shoes” and associating the keyword with a frequency, as shown in FIG. 10. Also, the category score calculation unit 32 extracts a plurality of keywords from the text information of the web page. For example, it is assumed that the text information is extracted as “leather shoes brown.” It is also assumed that “leather,” “shoes” and “brown” are selected as 1-gram keywords, “leather shoes” and “brown shoes” are selected as 2-gram keywords, and “leather brown shoes” is selected as a 3-gram keyword. The category score calculation unit 32 calculates a category score X based on a ranking N and the number Y of words of the keyword shown in FIG. 10. For example, the category score may be calculated as X=Y+Y/(log(N)+1). For example, for “leather,” N=1 and Y=1. For “shoes,” N=2 and Y=1. For “brown,” N=9 and Y=1. For “leather shoes,” N=10 and Y=2. The category score is a sum of scores of an n-gram. The category score calculation unit 32 executes the above process for each category. Further, for the extraction of the keyword, a combination of morphemes of the keyword may be determined to limit the extraction. For example, in the case of “noun, noun” and “adjective, noun,” the extraction may be determined to be performed, and in the case of “noun, adjective,” the extraction may be determined not to be performed. When the process of S64 is terminated, the control process proceeds to a total score calculation process (S66).

In the process of S66, the advertisement selection unit 34 calculates a total score of each advertisement. The advertisement selection unit 34 calculates the total score of each advertisement based on the word score calculated in the process of S62 and the category score calculated in the process of S64. For example, the two scores may be added or the one score may be weighted and added to the other score. When the process of S66 is terminated, the control process proceeds to a ranking process (S68).

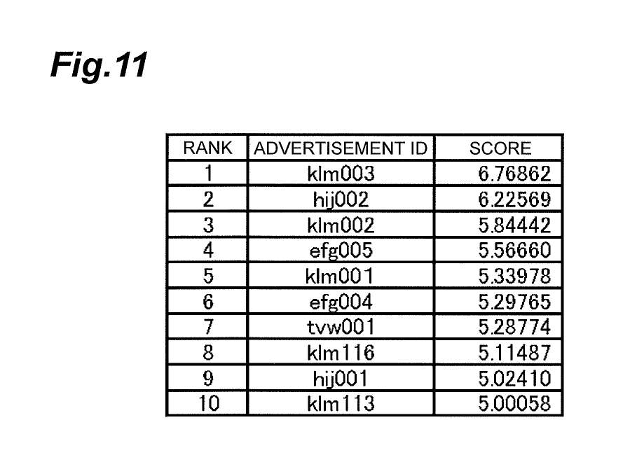

In the process of S68, the advertisement selection unit 34 performs ranking in descending order of the total score calculated in the process of S66. This process will be described with reference to FIG. 11. FIG. 11 is an example of a score ranking of advertisements. The advertisement IDs are arranged in descending order of the total score, as shown in FIG. 11. When the process of S68 is terminated, the control process proceeds to a display advertisement identifying process (S70).

In the process of S70, the advertisement selection unit 34 selects an advertisement based on the ranking produced in the process of S68. For example, if the number of advertisement insertion frames of the web page is 5, advertisements of rankings 1 to 5 are identified as advertisements to be inserted. When the process of S70 is terminated, the control process shown in FIG. 9 ends.

Thus, the control process shown in FIG. 9 ends. As the control process shown in FIG. 9 is executed, the relevance to the web page is evaluated based on the word score and the category score, and an advertisement having high evaluation, namely, the advertisement having a high relevance to the web page, is selected. Further, the advertisement selection unit 34 may provide the selected advertisement to the web server 10 to be displayed on the web page.

Next, an advertisement management program for causing a computer to function as the advertisement management device 1 will be described.

The advertisement management program includes a main module, a division target category identifying module, a reclassification module, an integration target category identifying module, and an integration module.

The main module is a part that performs overall control of advertisement management. Functions realized by executing the division target category identifying module, the reclassification module, the integration target category identifying module, and the integration module are similar to the functions of the division target category identifying unit 38, the reclassification unit 39, the integration target category identifying unit 40 and the integration unit 41, respectively.

The advertisement management program is, for example, provided as an aspect recorded in a recording medium or a semiconductor memory, such as a CD-ROM, a DVD or a ROM. Further, the advertisement management program may be provided over a communication network as a computer data signal superimposed on carrier waves.

As described above, according to the advertisement management device 1 according to the first embodiment, the number of advertisements associated with the same category is acquired by the integration target category identifying unit 40 based on the advertisement information. The integration target category that is the category of which the number of advertisements is equal to or less than a predetermined threshold is identified. The advertisement associated with the integration target category is associated with a category different from the integration target category and the advertisement information is updated by the integration unit 41. When the number of advertisements associated with one category is smaller, an influence of one advertisement on the characteristic of the category is greater. Therefore, when the characteristic of the category is identified with the characteristic of the advertisement belonging to the category, and when one of the advertisements belonging to the category has a unique characteristic that other advertisements do not have, relevance between a concept of the category and content of the advertisement belonging to the category may be degraded. Therefore, it is possible to suppress the degradation of the relevance between the category and the advertisement included in the category by integrating the categories of which the number of advertisements is equal to or less than a predetermined threshold.

Further, according to the advertisement management device 1 according to the first embodiment, the integration target category that is the category of which a total number of displays of advertisements associated with the same category is equal to or less than a predetermined threshold is identified by the integration target category identifying unit 40 based on the advertisement information. The advertisement associated with the integration target category is associated with a category different from the integration target category and the advertisement information is updated by the integration unit 41. In the case of the category of which the total number of displays is small, existence of the category itself may be inappropriate. Therefore, it is possible to suppress degradation of the relevance between the category and the advertisements included in the category by performing integration when the total number of displays is equal to or less than the predetermined threshold.

Further, according to the advertisement management device 1 according to the first embodiment, since the degree of similarity between the feature word extracted from the advertisement associated with the integration target category and the name of the category different from the integration target category is calculated, the advertisement included in the category of which the calculated degree of similarity is equal to or more than a predetermined threshold and the advertisement associated with the integration target category are associated with a new category, and the advertisement information is updated, integration with the category having the name similar to the characteristic of the advertisement can be performed.

Further, with the advertisement management device 1 according to the first embodiment, since the degree of similarity between the name of the integration target category and the name of the category different from the integration target category is calculated, the advertisement included in the category of which the calculated degree of similarity is equal to or more than a predetermined threshold and the advertisement associated with the integration target category are associated with a new category, and the advertisement information is updated, categories having similar category names can be integrated.

Further, according to the advertisement server 30 according to the first embodiment, it is possible to select the advertisement using the word score and the category score based on the advertisement information classified into appropriate categories. Therefore, it is possible to select an advertisement most suitable for content of the web page.

Further, according to the advertisement management method, the advertisement management program and the recording medium according to the first embodiment, it is possible to achieve the same effects as the advertisement management device 1 described above.

(Second embodiment) An advertisement management device 1 according to a second embodiment is configured similarly to the advertisement management device 1 according to the first embodiment, and differs in only an advertisement selection operation of the advertisement server 30. Hereinafter, a difference between the second embodiment and the first embodiment will be mainly described in consideration of ease of understanding of a description, and a repeated description is omitted.

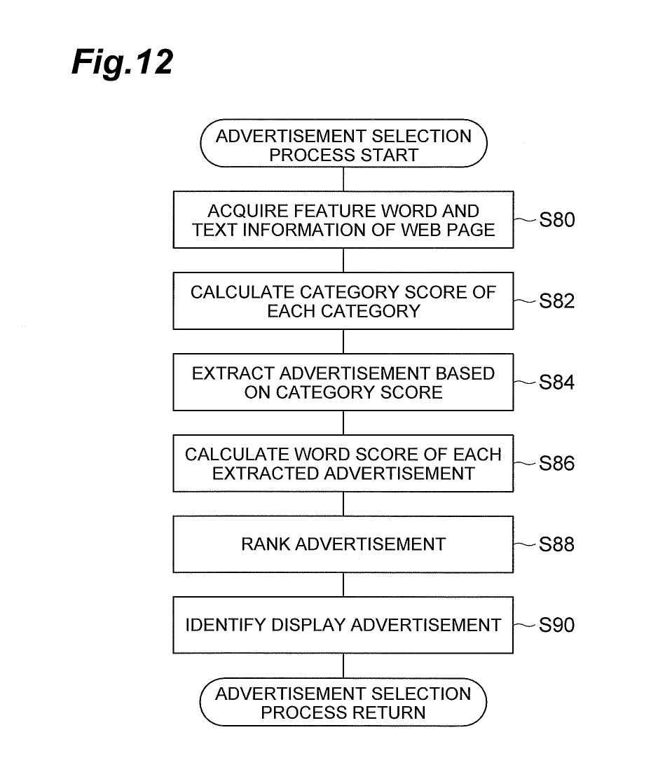

FIG. 12 is a flowchart illustrating an advertisement selection operation of the advertisement server 30 according to the present embodiment. The control process shown in FIG. 12 is executed, for example, according to a request from the web server 10.

First, the web information acquisition unit 31 acquires a feature word and text information of a web page, as shown in FIG. 12 (S80). When the process of S80 is terminated, the control process proceeds to a category score calculation process (S82).

In the process of S82, the category score calculation unit 32 calculates a category score based on the text information acquired in the process of S80 and the text information stored in the advertisement information table. This process is similar to the process of S64 in FIG. 9. When the process of S82 is terminated, the control process proceeds to an advertisement extraction process (S84).

In the process of S84, the word score calculation unit 33 extracts an advertisement based on the category score acquired in the process of S82. For example, the word score calculation unit 33 identifies the category whose category score is equal to or more than a predetermined threshold (e.g., 40000), and extracts an advertisement associated with the category. Alternatively, the word score calculation unit 33 may identify categories in descending order of the category score, and extract advertisements associated with the categories until the number of advertisements reaches a predetermined number. When the process of S84 is terminated, the control process proceeds to a word score calculation process (S86).

In the process of S86, the word score calculation unit 33 calculates a word score of each advertisement extracted in the process of S84. A scheme of calculating the word score is similar to the process of S62 in FIG. 9. When the process of S86 is terminated, the control process proceeds to a ranking process (S88).

In the process of S88, the advertisement selection unit 34 performs ranking in descending order of the word score calculated in the process of S88. This process is substantially the same as the process of S68 in FIG. 9. When the process of S88 is terminated, the control process proceeds to a display advertisement identifying process (S90).

In the process of S90, the advertisement selection unit 34 selects an advertisement based on the ranking produced in the process of S68. This process is similar to the process of S70 in FIG. 9. When the process of S90 is terminated, the control process shown in FIG. 12 ends.

Thus, the control process shown in FIG. 12 ends. As the control process shown in FIG. 12 is executed, relevance to the web page is evaluated based on the word score and the category score, and an advertisement having a high evaluation, namely, an advertisement having high relevance to the web page, is selected. Further, since the categories are organized to some extent and then evaluation can be performed in units of advertisements, it is possible to achieve a high-speed process.

Thus, with the advertisement server 30 according to the second embodiment, it is possible to achieve the same action effects as the advertisement server 30 according to the first embodiment and achieve a high-speed process.

Further, in each embodiment described above, the examples of the advertisement management device, the advertisement selection device, the advertisement management method, the advertisement management program and the recording medium according to the present invention are shown, and the present invention is not limited thereto.

For example, the web server 10 and the advertisement server 30 may be configured as one server. Further, the advertisement information DB 35 may be configured to be able to be referred to and updated by the advertisement server 30 or may be stored in a device separate from the advertisement server 30. Further, the division function, the integration function, and the advertisement selection function of the advertisement server 30 may be realized by a separate server, as necessary. Further, only one of the division function and the integration function of the advertisement server 30 may be included.

### REFERENCE SIGNS LIST

1 . . . Advertisement management device, 30 . . . Advertisement server (advertisement selection device), 31 . . . Web information acquisition unit (web information acquisition means), 32 . . . Category score calculation unit (category score calculation means), 33 . . . Word score calculation unit (word score calculation means), 34 . . . Advertisement selection unit (selection means), 38 . . . Division target category identifying unit (division target category identifying means), 39 . . . Reclassification unit (reclassification means), 40 . . . Integration target category identifying unit (integration target category identifying means), 41 . . . Integration unit (integration means).

1. An advertisement management device for managing an advertisement using advertisement information including information indicating association of an advertisement with a category, the advertisement management device comprising:
an integration target category identifying means that identifies an integration target category based on the advertisement information, the integration target category being a category in which the number of advertisements associated with the same category is equal to or less than a predetermined threshold; and
an integration means that associates the advertisement associated with the integration target category with a category different from the integration target category and updates the advertisement information.

2. An advertisement management device for managing an advertisement using advertisement information including information indicating association of an advertisement with a category and a history of the number of displays of the advertisement, the advertisement management device comprising:
an integration target category identifying means that identifies an integration target category based on the advertisement information, the integration target category being a category in which a sum of the numbers of displays of advertisements associated with the same category is equal to or less than a predetermined threshold; and
an integration means that associates the advertisement associated with the integration target category with a category different from the integration target category and updates the advertisement information.

3. The advertisement management device according to claim 1, wherein:
the integration means
calculates a degree of similarity between a feature word extracted from the advertisement associated with the integration target category and a name of the category different from the integration target category, and
associates an advertisement included in the category whose calculated degree of similarity is equal to or more than a predetermined threshold and the advertisement associated with the integration target category with a new category and updates the advertisement information.

4.-9. (canceled)

10. The advertisement management device according to claim 2, wherein:
the integration means
calculates a degree of similarity between a feature word extracted from the advertisement associated with the integration target category and a name of the category different from the integration target category, and
associates an advertisement included in the category whose calculated degree of similarity is equal to or more than a predetermined threshold and the advertisement associated with the integration target category with a new category and updates the advertisement information.

11. The advertisement management device according to claim 1, wherein:
the integration means
calculates a degree of similarity between a name of the integration target category and a name of the category different from the integration target category, and
associates an advertisement included in the category whose calculated degree of similarity is equal to or more than a predetermined threshold and the advertisement associated with the integration target category with a new category and updates the advertisement information.

12. The advertisement management device according to claim 2, wherein:
the integration means
calculates a degree of similarity between a name of the integration target category and a name of the category different from the integration target category, and
associates an advertisement included in the category whose calculated degree of similarity is equal to or more than a predetermined threshold and the advertisement associated with the integration target category with a new category and updates the advertisement information.

13. An advertisement selection device including the advertisement management device according to claim 1, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

14. An advertisement selection device including the advertisement management device according to claim 2, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

15. An advertisement selection device including the advertisement management device according to claim 3, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

16. An advertisement selection device including the advertisement management device according to claim 10, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

17. An advertisement selection device including the advertisement management device according to claim 11, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

18. An advertisement selection device including the advertisement management device according to claim 12, wherein:
the advertisement information further includes information indicating association of an advertisement with a keyword, and information indicating association of the advertisement with text information, and
the advertisement selection device includes:
a web information acquisition means that acquires a feature word and text information from a web page designated by a user;
a word score calculation unit that calculates a word score indicating a degree of linguistic relevance for each advertisement based on the feature word of the web page and the keyword associated with the advertisement;
a category score calculation unit that calculates a category score indicating a degree of linguistic relevance for each category based on the text information of the web page and the text information associated with the advertisement; and
a selection means that selects an advertisement to be displayed on the web page based on the word score and the category score.

19. An advertisement management method by an advertisement management device for managing an advertisement using advertisement information including information indicating association of an advertisement with a category, the advertisement management method comprising:
an integration target category identifying step of identifying an integration target category based on the advertisement information, the integration target category being a category in which the number of advertisements associated with the same category is equal to or less than a predetermined threshold; and
an integration step of associating the advertisement associated with the integration target category with a category different from the integration target category and updating the advertisement information.

20. An advertisement management method by an advertisement management device for managing an advertisement using advertisement information including information indicating association of an advertisement with a category and a history of the number of displays of the advertisement, the advertisement management method comprising:
an integration target category identifying step of identifying an integration target category based on the advertisement information, the integration target category being a category in which a sum of the numbers of displays of advertisements associated with the same category is equal to or less than a predetermined threshold; and
an integration step of associating the advertisement associated with the integration target category with a category different from the integration target category and updating the advertisement information.
